(19) United States
(12) Patent Application Publication
(10) Pub. No.: US 2011/0105684 A1
(43) Pub. Date: May 5, 2011

(54) FATTY ACID MODIFIED POLYESTERAMIDE RESIN AND COMPOSITION

(75) Inventors: Rudolfus Antonius Theodorus Maria Van Benthem, Limbricht (NL); Franciscus Johannes Marie Derks, Heythuysen (NL); Joseph Petronella Friederichs, Wessem (NL)

(73) Assignee: DSM IP ASSETS B.V, Heerlen (NL)

(21) Appl. No.: 12/933,472

(22) PCT Filed: Mar. 19, 2009
(86) PCT No.: PCT/EP2009/053272

§ 371 Date: Jan. 13, 2011

(30) Foreign Application Priority Data
Mar. 20, 2008 (EP) 08005233.5

(51) Int. Cl. C09D 177/12; C08G 69/44; C08L 77/12; B05D 3/00

(52) U.S. Cl. 524/608; 528/339.5; 524/607; 427/385.5

(57) ABSTRACT

The invention relates to a fatty acid modified polyesteramide resin obtained from components comprising: i) at least one α, β- unsaturated diacid; ii) optionally at least one other diacid and/or anhydride; iii) at least one alkanol-amine; and iv) at least one fatty acid and/or fatty acid derivative; wherein the molar ratio of component iii): [component i)+component ii)] is in the range of from 1.2:1.0 to 3.0:1.0; and wherein component iv) is incorporated in the polyesteramide resin in the range of from 18 to 60 wt % based on the total weight of components i) to iv).

The invention relates to a polyesteramide resin functionalised with fatty acid groups and a method for preparing such resin; it also relates to a pigment paste and a composition comprising at least said polyesteramide resin, to a method for coating said composition onto a substrate and a substrate fully or partially coated with said composition.

In general, paint manufacturers produce paints by adding their choice of additional components to a coating composition comprising a resin functioning as a binder. Paint manufacturers in general choose different components and resins when producing water-borne paints or when producing solvent-borne paints. Thus a paint manufacturer who produces both types of paints, water-borne and solvent-borne, needs a large variety of components and resins, as each component or resin is usually suitable for only one kind of paint, either water- or solvent-borne. This is due to various reasons, for example different pigments or other additives that are needed for solvents of different nature. It would be very advantageous, for paint manufacturers as well as for the end-users, when one resin would be available for compositions that can be dissolved both in water and organic solvent.

Pigment pastes, i.e. concentrated compositions comprising a mixture of pigment, resin and optionally solvent, which pastes can be easily dissolved into a paint composition for ensuring a specific color, are also difficult to dissolve both in water and in organic solvent. Coatings compositions containing pigment paste usually require the addition of suitable dispersants for a good dispersion of pigment particles into the specific solvent (i.e. water or the organic solvent) that forms the continuous phase of the coating composition. For water-borne coating compositions for example, usually dispersants having polyethylene glycol functionality are used. One disadvantage of polyethylene glycol functionalised dispersants is that addition of pigment paste to the coating composition will often result in a decrease in the hardness of the coating.

It would be therefore highly advantageous to have available not only a resin presenting dual solubility but also to provide good wetting and/or dispersant properties for the pigment particles, regardless of the type of solvent.

Various solutions were proposed to solve the problem of solubility both in water and in organic solvent, which is desirable for coating compositions.

U.S. Pat. No. 5,723,537 describes a mixture of a water-soluble polyacrylate and a solvent-soluble polyester resin along with the use of a large amount of co-solvent. U.S. Pat. No. 4,410,657 describes a copolymer from acrylic (solvent-soluble) and N-vinylic monomers (water-soluble), also in the presence of a co-solvent. The disadvantage of both suggested solutions is that the presence of a co-solvent is necessary to homogenize mixtures of polymers and water; without the co-solvent the problem of dual solubility cannot be solved. The use of co-solvents in pigment pastes has several disadvantages. First of all, a large amount of co-solvent needs to be used to obtain a good viscosity range for a corresponding coating composition. Additionally, besides the fact that it is costly and thus less economical, after applying a coating composition containing such co-solvents, evaporation of a large amount of co-solvent takes place and that may have undesirable environmental and health effects. Also the levels of co-solvents that increase the VOC (volatile organic compound) level are more and more regulated by law. All the above-mentioned issues would certainly be disadvantageous also from the point of view of the consumer.

A class of resins widely used for paints is the polyester resins class. From this class, a special interest in the coatings and paints field concerns hyperbranched polyesteramide resins due to their large variety of properties obtainable by a controlled design of the resin.

A hyperbranched polyesteramide resin is a polymer having branched (non-linear) structure with a functionality ≧2 obtained by the polycondensation of for example anhydride with an alkanol-amine. Functionality is understood to be the average number of reactive groups of a certain type per molecule in the resin composition. WO 99/16810 discloses details regarding such hyperbranched polyesteramides and the processes used to produce polyesteramides in general.

Such hyperbranched polyesteramide resin has the advantage that can be easily be tailored to be suitable for water- and/or solvent-borne systems by the variation of the polar/apolar building blocks of said resin. Another advantage is that the resin is transparent and additionally a composition containing the polyesteramide resin is quickly hardened and has an increased hardness in comparison with many other known dispersants, having polyethylene glycol functionality.

For example, WO 00/32708 discloses an airdrying coating composition, which coating composition comprises a hyperbranched polyesteramide containing at least two carboxyalkylamide groups derived from an unsaturated acid with from 10 to 28 carbon atoms. The disadvantage of the airdrying coating compositions disclosed in WO 00/32708 is however that such compositions are only solvent-soluble. The coating composition cannot therefore be used for water-soluble systems.

In WO 2007/147559 an airdrying coating composition is disclosed suitable for both water- and solvent-borne systems, which coating composition comprises a polyesteramide obtained by reacting an unsaturated anhydride and an alkanol-amine, functionalised with unsaturated fatty acid groups incorporated in the resin in an amount equivalent to an oil length from 15 and 40%. However, a disadvantage that may be encountered in the preparation of polyesteramides according to WO 2007/147559 (including the polyesteramides disclosed in the examples of WO 2007/147559 comprising maleic anhydride) is the formation of a foam-like material that often occurs during or after the mixing of the components. This foam is a mixture of gas and resin that may be difficult to separate into the two components. The volume of the gas obtained may be of several times the volume of the reactor wherein the resin is prepared and can lead to severe spoiling of the equipment and build up of internal pressure. For example, when maleic anhydride is used in the preparation of a polyesteramide resin, it must be added slowly in small portions in the polyesteramide resin composition while mixing and even then it is possible for a lot of foaming to occur. Foaming disturbs the composition and can lead to safety issues (exothermic runaway) and/or production failures such as clogging of the reactor outlets. Without wishing to be bound by a theory, it is believed that tertiary amines, formed by the aza-Michael reaction, lead to the decomposition of α, β-unsaturated anhydride such as maleic anhydride, resulting in the formation of gases such as carbon dioxide and potentially also carbon monoxide and/or acetylene, which in combination with the polyesteramide resin forms the foam-like material.

It is an object of the invention to provide a polyesteramide resin which can be dispersed or dissolved both in water- and solvent-borne coating compositions and which does not have the drawback of the foaming during the polycondenstation reaction.

Surprisingly, it was found that a fatty acid modified polyesteramide resin derived from α, β-unsaturated diacid optionally in combination with another diacid or anhydride, or even α, β-unsaturated diacid alone (not combined with other diacid or anhydride), can be an advantageous solution for the requirements of dual solubility, without having the typical foaming disadvantages associated with the use of α, β-unsaturated anhydride.

This is especially surprising since in the polyester field diacids and their anhydrides are generally known to behave in a similar manner and therefore one would expect that foaming would occur both when using an anhydride and its diacid. Without wishing to be bound by a theory, a possible reason for no foam formation during the polycondensation reaction (i.e. no release of gases) may be a different reactivity of the α, β-unsaturated diacids compared to their anhydrides such that there is no formation of an instable intermediate compound that will decompose with formation of gas.

Thus, one of the main advantages of using α, β-unsaturated diacid instead of α, β-unsaturated anhydride is that during the manufacturing process foaming is substantially or even fully avoided. Moreover, the fatty acid modified polyesteramide resin according to the invention is both water- and organic solvent-soluble, having a combination of properties desirable for different types of applications.

In the present invention, to obtain the required properties, the polyesteramide resin was chosen such as to have three principle building blocks: a) α, β-unsaturated diacid and optionally other diacid and anhydride, b) alkanol-amine and c) fatty acid and/or fatty acid derivative groups. The presence of α, β-unsaturated diacid as polar building blocks of the core of the polyesteramide resin and of the OH—end groups determines the increased hydrophilicity of the polyesteramide resin whereas the apolar fatty acid tails ensure the presence of more hydrophobic building blocks. Such structure provides better wetting and/or dispersant properties for mixing pigment into the coating composition and making it suitable for both water- and solvent-borne coating compositions.

Optionally, α, β-unsaturated anhydride may be included as a component of the polyesteramide resin composition according to the invention. If included, the amount of α, β-unsaturated anhydride is preferably less than 20 wt % and more preferably less than 10 wt % of the total amount diacid and/or anhydride [component i)+component ii)]. Most preferably no α, β-unsaturated anhydride are present in the composition of the polyesteramide resin according to the invention.

Preferably the polyesteramide according to the invention is a hyperbranched polyesteramide resin having a branched structure with a hydroxyalkylamide functionality ≧2, more preferably between 2 and 250 and most preferably between 3 and 50.

For the clarity, the terms diacid, anhydride, fatty acid, alkanol-amine, polyesteramide comprise both singular and plural.

According to the invention there is provided a fatty acid modified polyesteramide resin obtained from components comprising:
i) at least one α, β-unsaturated diacid;
ii) optionally at least one other diacid and/or anhydride;
iii) at least one alkanol-amine; and
iv) at least one fatty acid and/or fatty acid derivative;
wherein the molar ratio of component iii):[component i)+component ii)] is in the range of from 1.2:1.0 to 3.0:1.0; and
wherein component iv) is incorporated in the polyesteramide resin in the range of from 18 to 60 wt % based on the total weight of components i) to iv).

Examples of component i) include α, β-unsaturated diacid selected from the group consisting of maleic acid, fumaric acid, mesaconic acid, citraconic acid and itaconic acid and mixtures thereof. Preferably component i) is selected from a group consisting of itaconic acid, maleic acid, fumaric acid and mixtures thereof. It is possible even to use 100% of α, β-unsaturated diacid such as the fumaric acid and still no foaming will occur during the process of polyesteramide resin formation.

Optionally, other diacid and/or anhydride may be added (component ii)). Examples of component ii) include diacid and/or anhydride selected from a group consisting of succinic acid, glutaric acid, diglycolic diacid, phthalic acid, hexahydrophthalic acid, tetrahydrophthalic acid, succinic anhydride, glutaric anhydride, diglycolic anhydride, phthalic anhydride, hexahydrophthalic anhydride, tetrahydrophthalic anhydride, citraconic anhydride, itaconic anhydride, (C4-C18)-alkenylsuccinic diacids and their anhydrides, and mixtures thereof.

Preferably the molar amount of component i) in respect of the total amount of diacid and/or anhydride [component i)+component ii)] is from 100% to 10%. More preferably, the molar amount of component i) in respect of the total amount of diacid and/or anhydride [component i)+component ii)] is from 70 to 30%. Preferably component i), more preferably fumaric acid, itaconic acid and/or maleic acid, is present in the total amount of diacid and/or anhydride in a substantial amount. Preferably the molar ratio of component i): component ii) is ≧1:1, such that component i) is preferably more than 50% of the total amount of diacid and/or anhydride. A molar ratio of from 1:1 to 9:1 for component i) to component ii) assures an even better water solubility.

Component iii), the alkanol-amine, may be a monoalkanol-amine, a dialkanol-amine, a trialkanol-amine and mixtures thereof. The degree of branching of the polyesteramide resin according to the invention can be set via the alkanol-amines chosen. Hyperbranched structures with functionality ≧2 use as starting components di- and trialkanol-amines. Examples of suitable alkanol-amines included by component iii) are for example described in WO 00/32708, page 10, lines 31-35; page 11 and page 12, lines 1-11. By preference, a dialkanol-amine and more preferrably diisopropanolamine (DIPA) and/or diethanolamine is chosen.

The molar ratio (D:A) of component iii):[component i)+component ii)] is preferably in the range of from 1.2:1.0 to 2.5:1.0 and most preferably in the range of from 1.4:1.0 to 2.5:1.0.

The molar ratio (D:A) is chosen such as to include alkanol-amine in the form of a single alkanol-amine or a combination of two or more alkanol-amines, regardless whether only α, β-unsaturated diacid such as maleic or fumaric acid, or a combination of the α, β-unsaturated diacid with other diacid or anhydride is used in the polyesteramide resin composition of the invention.

Component iv) is a fatty acid and/or a fatty acid derivative. By fatty acid derivative hereby is meant fatty acid esters, fatty acid chlorides, fatty acid anhydrides and fatty acid triglycerides.

The fatty acid used in the preparation of the polyesteramide according to the invention will generally be a fatty acid having from 8 to 22 carbon atoms and preferably from 8 to 18 carbon atoms. In general, both saturated and unsaturated fatty acid groups and mixtures of all kinds of fatty acids can be used to obtain the fatty acid modified polyesteramide according to the invention.

Examples of suitable saturated aliphatic fatty acids include 2-ethyl hexanoic acid, lauric acid, versatic acid and stearic acid. Examples of suitable unsaturated fatty acids include dehydrated castor oil fatty acid, linoleic acid and/or linolenic acid. Examples of useful natural oil fatty acids are tall oil fatty acid, sunflower oil fatty acid, corn oil fatty acid, cottonseed oil fatty acid, peanut oil fatty acid, linseed oil fatty acid, soybean oil fatty acid, rapeseed oil fatty acid, rice bran oil fatty acid, safflower oil fatty acid and/or sesame oil fatty acid.

Example of suitable fatty acid esters and fatty acid triglycerides are methyl linoleate, ethyl linoleate, ethyl linolenate, ethyloleate, sunflower oil, soybean oil, safflower oil, linseed oil, tung oil and arachide oil. Preferably, not more than 50% by weight of fatty acid esters, triglycerides, chlorides or anhydrides are used in respect of the total weight of component iv), more preferably only fatty acids are used.

The amount of component iv) incorporated into the modified polyesteramide resin composition of the invention is preferably in the range of from 18 to 50 wt %, even more preferably from 20 to 40 wt % and most preferably from 20 to 30 wt %, based on the total weight of components i) to iv) used for producing the polyesteramide resin.

When the polyesteramide resin according to the invention contains in its composition maleic acid, fumaric acid or other α, β-unsaturated diacid (which have reactive double bonds) and the alkanol-amine is a dialkanol-amine, then the ratio F:(D−A) preferably ranges from 3.0:2.0 to 1.0:5.0, more preferably from 3.0:2.0 to 1.0:4.0, even more preferably from 3.0:2.0 to 1.0:3.0 and most preferably from 1.0:1.0 to 1.0:3.0, wherein
F=the molar amount of component iv)
D=the molar amount of component iii)
A=the total molar amount of diacid and anhydride [component i)+component ii)]

The ratio F:(D−A) may be expressed also as a single number, in which case the ratio F:(D−A) as given above preferably ranges from 1.5 to 0.2, more preferably from 1.5 to 0.25, even more preferably from 1.5 to 0.33 and most preferably from 1 to 0.33.

In a preferred embodiment there is provided a polyesteramide resin prepared from:
i) at least one α, β-unsaturated diacid;
ii) optionally at least one other diacid and/or anhydride;
iii) at least one alkanol-amine; and
iv) at least one fatty acid and/or fatty acid derivative;
wherein the molar amount of component i) in respect of the total amount of diacid and/or anhydride [component i)+component ii)] is from 100% to 10%;
wherein the molar ratio of component iii):[component i)+component ii)] is in the range of from 1.2:1.0 to 3.0:1.0;
wherein the ratio F:(D−A) preferably ranges from 3.0:2.0 to 1.0:5.0; and wherein component iv) is incorporated in the polyesteramide resin in the range of from 18 to 60 wt % based on the total weight of components i) to iv).

The polyesteramide resin according to the invention may furthermore comprise at least one functional group built in the molecule via different mechanisms known in the art, depending on the type of functionality. Such functionality may be included in the polyesteramide molecule by having for example the starting components of the polyesteramide resin of the invention themselves functionalised before being reacted to make the polyesteramide resin, or by functionalising the polyesteramide after its preparation. Preferred functionalities are selected from but not limited to carboxylic acid, esters, polyethylene oxide, polypropylene oxide, amines, tertiary amines, quaternary amines, cyclics, heterocyclics and mixtures thereof.

According to the invention there is also provided a process for preparing a fatty acid modified polyesteramide resin comprising the polycondensation of components comprising:
i) at least one α, β-unsaturated diacid;
ii) optionally at least one other diacid and/or anhydride;
iii) at least one alkanol-amine; and
iv) at least one fatty acid and/or fatty acid derivative;
wherein the molar ratio of component iii):[component i)+component ii)] is in the range of from 1.2:1.0 to 3.0:1.0; and
wherein component iv) is incorporated in the polyesteramide resin in the range of from 18 to 60 wt % based on the total weight of components i) to iv).

The components may be reacted all together in one step or in any order.

There are two preferred processes for the preparation of the fatty acid modified polyesteramide resin according to the invention.

One preferred process (I) for the preparation of the fatty acid modified polyesteramide resin comprises the following steps:
1. charging a reactor with component iii) and optionally also with component ii);
2. adding component i) to the components charged in step 1 at a temperature of from 40 to 80° C.;
3. when all the component i) is charged in the reactor, increasing the temperature to a value of from 120 to 180° C.;
4. adding component iv) to the composition of step 3; after which
5. a fatty acid modified polyesteramide resin is obtained through polycondensation at the temperature of from 120 to 180° C.

A second preferred process (II) for the preparation of the fatty acid modified polyesteramide resin comprises the following steps:
1. charging a reactor with component iii), with component iv) and optionally with component ii);
2. adding component i) to the components charged in step 1 at a temperature of from 40 to 60° C.;
3. when all the component i) is charged in the reactor, increase the temperature to a value of from 120 to 180° C.; after which
4. a fatty acid modified polyesteramide resin is obtained through polycondensation at the temperature of from 120 to 180° C.

Alternatively, the fatty acid modified polyesteramide resin may be obtained by first making a polyesteramide via polycondensation and then reacting component iv) (the fatty acid and/or its derivative) to the polyesteramide.

The reaction water obtained during polycondensation can be removed by methods known to the person skilled in the art, for example distillation, azeotropic distillation, etc. Preferably the reaction water is removed through distillation.

A fatty acid modified polyesteramide resin according to the invention can for example be used as a component in pigment pastes, as a sole resin or as a mixture of resins (i.e. as an assisting binder for a better dispersion), as well as being suitable for use in a pigmented or a non-pigmented coating composition.

The polyesteramide resin according to the invention can for example be used as an additive in water-borne or solvent-borne compositions. Examples of the use as additives may be as: dispersant for pigments, hardness modifier, rheology modifier, in water- and solvent-based paint compositions or as surfactant. As an additive, the polyesteramide resin according to the invention can be used both in airdrying and non-airdrying compositions.

The invention also relates to a pigment paste comprising the polyesteramide resin according to the invention.

An embodiment of the invention is related to a pigment paste comprising at least one polyesteramide according to the invention and at least one pigment. Preferably, the pigment paste comprises a total amount of polyesteramide resin according to the invention in the range of from 5 to 50 wt %, more preferably from 5 to 35 wt % and most preferably from 5 to 25 wt %. The pigment paste may additionally comprise at least one liquid component selected from the group consisting of water, organic solvent and mixtures thereof. Preferably the pigment paste is diluted with water or aqueous liquid components. The pigment pastes may comprise small amounts of solvents, however the presence of solvent is generally not required, nor expected especially in view of the current trend to lower the amount of volatile organic compounds (VOC).

The invention also relates to a composition comprising at least one polyesteramide resin according to the invention and at least one liquid component selected from the group consisting of water, organic solvent and mixtures thereof. This composition may for example be made by diluting a pigment paste with a corresponding solvent and with optional addition of further additives, as shown below. Preferably, the composition comprises from 5 to 25 wt % of a polyesteramide resin according to the invention; from 15 to 65% of the liquid component selected from the group consisting of water, organic solvent and mixtures thereof; from 15 to 65 wt % pigment; and optionally, up to 4 wt % other additives.

Suitable organic solvents are well-known in the art and, in principle, all can be used in the coating compositions contemplated herein. Non-limiting examples of suitable organic solvents are aliphatic, cycloaliphatic, and aromatic hydrocarbons, alcohol ethers, and alcohol ether acetates and mixtures thereof. As examples of such solvents may be mentioned hydrocarbon solvents available under the trademarks Shellsol H, Shellsol K, and Shellsol AB, all from Shell Chemicals, the Netherlands; the trademarked Solvesso 150, Exxsol D30, Exxsol D40 and Exxsol D60 solvents from Esso; ester solvents such as ethyl diglycol, ethyl glycol acetate, butyl glycol, butyl glycol acetate, butyl diglycol, butyl diglycol acetate, and methoxypropylene glycol acetate; and ketone solvents like methyl ethyl ketone (MEK), acetone, methyl isobutyl ketone (MIBK) and methyl amyl ketone (MAK); xylene or white spirit. Mixtures of solvents may also be used. Preferably the solvent is an aliphatic solvent and most preferably the solvent is Exxsol D40 and/or Exxol D60. Dowanol PM may be used as co-solvent.

The composition of the invention may be used in various applications, and for such purposes may be further optionally combined or formulated with other additives or components (to form compositions), such as pigments (for example titanium dioxide, iron oxide, chromium based compounds and/or metal pthalocyanine compounds), dyes, defoamers, rheology control agents, thixotropic additives, thickeners, dispersing and stabilising agents (usually surfactants), heat stabilisers, matting agents such as silica, wetting agents, levelling agents, anti-cratering agents, fillers, extenders, sedimentation inhibitors, UV absorbers, antioxidants, drier salts, fungicides, bacteriocides, waxes, organic co-solvents, wetting agents and the like introduced at any stage of the production process or subsequently. It is possible to include an amount of antimony oxide to enhance the fire retardant properties. The composition of this invention may also contain various other ingredients such as extenders (e.g. calcium carbonate and china clay) and dispersants such as pigment dispersion aids.

The composition according to the invention as described above may be used in all kinds of coatings, for example: water-borne or solvent-borne coatings, powder coatings or radiation curable coatings.

The invention also relates to a coating comprising at least one polyesteramide resin according to the invention. The coating according to the invention may be primer coating or a topcoat.

There is further provided according to the invention a method of coating a substrate which comprises applying a composition as defined above to a substrate and drying the composition to obtain a coating. The composition once applied may be allowed to dry naturally at ambient temperature and more preferably the drying process may be accelerated by heat at a temperature in the range of from 10 to 28° C.

Application to a substrate may be by any conventional method including brushing, dipping, flow coating, spraying, roller coating, pad coating, flexo printing, gravure printing, ink-jet printing, any other graphic arts application methods and the like. For spraying, further dilution of the composition with a suitable solvent may be needed to achieve the best results.

The invention also relates to a substrate, fully or partially coated with a coating obtainable by using a composition comprising the polyesteramide resin of the invention.

There is further provided according to the invention a substrate carrying a pigmented or non-pigmented coating derived from a composition according to the invention.

Suitable substrates include wood, metal, stone, plastics and plastic films like polyethylene or polypropylene, especially when the films are treated with plasma; fibre (including hair and textile), glass, ceramics, plaster, asphalt, concrete, leather, paper, foam, masonry and/or board. Wood and wooden based substrates like MDF (medium density fiberboard) or chip boards are the most preferred substrates.

The present invention is now further illustrated but in no way limited by reference to the following examples. Unless otherwise specified all parts, percentages and ratios are on a weight basis. The term comparative means that it is not according to the invention.

### Method for Checking Foaming and Gas Formation

The polyesteramide resin compositions exemplified below were reacted in a closed glass reactor equipped with stirrer and condenser, having a volume of 1 liter. If gas was formed during the reaction, it was collected into a gas collector such that the pressure in the reactor was constantly at the atmospheric pressure. The gas collector indicated the volume of the gas obtained through the polycondensation reaction.

### EXAMPLE 1

### Polvesteramide Resin Made with Itaconic Acid and Succinic Anhydride

486 g diisopropanol amine (DiPA) and 299 g soya bean fatty acid were added to the reactor. The mixture was slowly heated to 60° C. and 130 g succinic anhydride and 170 g itaconic acid were added. Next the temperature was raised to 150° C. in 2 hours. To remove the reaction water slowly a vacuum was applied till the pressure was 20 mbar after 3 hours. After 9 h the reaction mixture was cooled and a soft polymer with an acid value of <5 mg KOH/g was obtained. No foaming was observed during the synthesis.

The resin was soluble in water as well as in white spirit. No phase separation occurred as established by visual inspection after 1 day.

Molar ratio DiPA:(unsaturated diacid+anhydride)==[3.5:(1.25+1.25)]:1=1.40:1

The amount of fatty acid was 30 weight % based on the total amount of components i) to iv).

F:(D−A)=1.0:(3.5−2.5)=1.0

### EXAMPLE 2

### Polyesteramide Resin Made with Maleic Acid and Succinic Acid

487 g diisopropanol amine and 208 g soya bean fatty acid were added to the reactor. The mixture was slowly heated to 60° C. and 154 g succinic acid and 151 g maleic acid were added. Next the temperature was raised to 150° C. in 2 hours. To remove the reaction water slowly a vacuum was applied till the pressure was 20 mbar after 3 hours. After 9 h the reaction mixture was cooled and a soft polymer with an acid value of <5 mg KOH/g was obtained. No foaming was observed during the synthesis.

The resin was soluble in water as well as in white spirit. No phase separation occurred as established by visual inspection after 1 day.

Molar ratio DiPA:(unsaturated diacid+saturated diacid)==[3.5:(1.25+1.25)]:1=1.40: 1

The amount of fatty acid was 23 weight % based on the total amount of components i) to iv).

F:(D−A)=0.71:(3.5−2.5)=0.71

### EXAMPLE 3

### Polyesteramide Resin Made with Maleic Acid, Succinic Acid, Dodecenylsuccinic Anhydride and A Mixture of Dipa and DEA

243 g diisopropanol amine, 192 diethanol amine (DEA) and 181 g soya bean fatty acid were added to the reactor. The mixture was slowly heated to 60° C. and 139 g dodecenylsuccinic anhydride, 92 g succinic acid and 151 g maleic acid were added. Next the temperature was raised to 150° C. in 2 hours. To remove the reaction water slowly a vacuum was applied till the pressure was 20 mbar after 3 hours. After 9 h the reaction mixture was cooled and a soft polymer with an acid value of <5 mg KOH/g was obtained. No foaming was observed during the synthesis.

The resin was soluble in water as well as in white spirit. No phase separation occurred as established by visual inspection after 1 day.

Molar ratio DiPA+DEA:(unsaturated diacid+saturated diacid+anhydride)=[(1.75+1.75):(1.25+0.75+0.50)]:1=1.40: 1.

The amount of fatty acid was 20 weight % based on the total amount of components i) to iv).

F:(D−A)=0.62:(3.5 −2.5)=0.62

### COMPARATIVE EXAMPLE 1

### Polyesteramide Made with Maleic and Succinic Anhydride (no α, β-Unsaturated Diacid)

The resin was made according preferred process (I) (fatty acid added after anhydrides).

469 g diisopropanol amine was added to the reactor. The mixture was slowly heated to 60° C. and 123 g maleic anhydride was added. Next the temperature was raised to 125° C. and the reaction mixture started foaming. The temperature was slowly further raised to 150° C. in 4 hours. The evolved gas was collected and was approximately 3800 ml (thus almost 4 times the volume of the reactor). Next 126 g succinic anhydride and 282 g soya bean fatty acid were added. To remove the reaction water slowly vacuum was applied till the pressure was 20 mbar after 3 hours. After 2 h the reaction mixture was cooled and a soft polymer with an acid value of <5 mg KOH/g was obtained. Because of the foaming it was very difficult to apply the vacuum and the top of the reactor and the condenser were spoiled with resin.

Molar ratio DiPA:(unsaturated diacid+anhydride)==[3.5:(0+1.25+1.25)]:1=1.40: 1

The amount of fatty acid was 30 weight % based on the total amount of components i) to iv).

F:(D−A)=1.0:(3.5 −2.5)=1.0

### COMPARATIVE EXAMPLE 2

### Polyesteramide Resin Made with Maleic and Succinic Anhydride (no α, β-Unsaturated Diacid)

The resin was made according preferred process (II) (fatty acid added before anhydrides).

469 g diisopropanol amine and 282 g soya bean fatty acid were added to the reactor. The mixture was slowly heated to 60° C. and 126 g succinic anhydride and 123 g maleic anhydride were added. Next the temperature was raised to 125° C. and the reaction mixture started foaming. The temperature was slowly further raised to 150° C. in 4 hours. The evolved gas was collected and was approximately 2550 ml (thus about 2.5 times the volume of the reactor). To remove the reaction water slowly vacuum was applied till the pressure was 20 mbar after 3 hours. After 2 h the reaction mixture was cooled and a soft polymer with an acid value of <5 mg KOH/g was obtained. Because of the foaming it was very difficult to apply the vacuum and the top of the reactor and the condenser were spoiled with resin.

Molar ratio DiPA:(unsaturated diacid+anhydride)==[3.5:(0+1.25+1.25)]:1=1.40:1

The amount of fatty acid was 30 weight % based on the total amount of components i) to iv).

F:(D−A)=1.0:(3.5−2.5)=1.0

### Preparation of Pigment Paste According to the Invention

The fatty acid modified polyesteramide resin of example 2 as described above is used as a dispersant in a pigment paste with the following formulation: 62% pigment Bayferrox 130 M., 1% Bentone SD-2, 10% polyesteramide resin of example 2 and 27% water.

The paste is milled in a standard way using glass beads resulting in a stable homogeneous pigment paste.

### Coating Compositions According to the Invention

A coating composition is prepared by mixing by standard means 3 grams of the above prepared pigment paste based on the polyesteramide resin of example 2 with 20 grams water-borne alkyd emulsion Uradil 554 (available from DSM NeoResins BV) and separately in same amounts with alkyd resin Uralac AD44 (available from DSM NeoResins BV) in white spirit, leading to coating compositions stable against phase separation which give smooth coatings/films with well dispersed pigment particles. The polyesteramide resin based pigment paste was found to be compatible (i.e. well dissolved) with both alkyd resin Uralac AD44 in white spirit (60%) and water born alkyd resin Uradil 554.

1. Fatty acid modified polyesteramide resin obtained from components comprising:
i) at least one α, β-unsaturated diacid;
ii) optionally at least one other diacid and/or anhydride;
iii) at least one alkanol-amine; and
iv) at least one fatty acid and/or fatty acid derivative;
wherein the molar ratio of component iii):[component i)+component ii)] is in the range of from 1.2:1.0 to 3.0:1.0; and
wherein component iv) is incorporated in the polyesteramide resin in the range of from 18 to 60 wt % based on the total weight of components i) to iv).

2. Resin according to claim 1 wherein component i) is selected from the group consisting of maleic acid, fumaric acid, mesaconic acid, citraconic acid, itaconic acid and mixtures thereof.

3. Resin according to claim 1 wherein the molar amount of component i) in respect of the molar amount of [component i)+component ii)] is in the range of from 100% to 10%.

4. Resin according to claim 1 characterized in that component ii) is selected from the group consisting of succinic acid, glutaric acid, diglycolic diacid, phthalic acid, hexahydrophthalic acid, tetrahydrophthalic acid, succinic anhydride, glutaric anhydride, diglycolic anhydride, phthalic anhydride, hexahydrophthalic anhydride, tetrahydrophthalic anhydride, citraconic anhydride, itaconic anhydride, (C4-C18)-alkenylsuccinic diacids and their anhydrides, and mixtures thereof.

5. Resin according to claim 1 characterized in that the ratio
F:(D−A) is in the range of from 3.0:2.0 to 1.0:5.0, wherein
F=the molar amount of component iv);
D=the molar amount of component iii);
A=the total molar amount of [component i)+component ii)].

6. Resin according to claim 1 wherein component iv) is selected from the group consisting of fatty acids, fatty acid esters, fatty acid chlorides, fatty acid anhydrides, fatty acid triglycerides and mixtures thereof.

7. Resin according to claim 1, wherein the alkanol-amine is a dialkanol-amine.

8. Resin according to claim 7 wherein the dialkanol-amine is diisopropanolamine and/or diethanolamine.

9. Resin according to claim 1 wherein the resin comprises at least one functional group selected from the group consisting of carboxylic acid, esters; polyethylene oxide, polypropylene oxide, amines, tertiary amines, quaternary amines, cyclics, heterocyclics and mixtures thereof.

10. Process for preparing a fatty acid modified polyesteramide resin comprising the polycondensation of components comprising:
i) at least one α, β-unsaturated diacid;
ii) optionally at least one other diacid and/or anhydride;
iii) at least one alkanol-amine; and
iv) at least one fatty acid and/or fatty acid derivative;
wherein the molar ratio of component iii):[component i)+component ii)] is in the range of from 1.2:1.0 to 3.0:1.0; and
wherein component iv) is incorporated in the polyesteramide resin in the range of from 18 to 60 wt % based on the total weight of components i) to iv).

11. Pigment paste comprising at least one resin according to claim 1 and at least one pigment.

12. Composition comprising at least one resin according to claim 1 and a liquid component selected from the group consisting of water, organic solvent and mixtures thereof.

13. Composition according to claim 12 comprising components:
15 to 65% of the liquid component selected from the group consisting of water, organic solvent and mixtures thereof;
5 to 25 wt % of a polyesteramide resin;
15 to 65 wt % pigment; and optionally, up to 4 wt % other additives.

14. Coating comprising at least one resin according to claim 1.

15. Method of coating a substrate comprising applying a composition according to claim 12 to a substrate and drying the composition to obtain a coating.

16. Substrate fully or partially coated with a composition according to claim 12.

17. Use of the resin according to claim 1 as an additive in water-borne or solvent-borne compositions.
